(19) United States
(12) Patent Application Publication
(10) Pub. No.: US 2005/0099999 A1
(43) Pub. Date: May 12, 2005

(54) Systems for providing information to users via communication networks

(76) Inventors: Daniel William Phillips, Cumming, GA (US); Mark Louis Goodman, Alpharetta, GA (US); David Warren Hostetter, Acworth, GA (US); Donny McDonald, Scotland (GB)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/703,968

(22) Filed: Nov. 7, 2003

(51) Int. Cl. H04L 12/66

(52) U.S. Cl. 370/352

(57) ABSTRACT

System for providing information to a user via a communication network are provided. One such system incorporates an integrated appliance that includes a housing. The housing mounts a display, a telephone, a keyboard and a first passthrough communication portal. The display is operative to display information to the user. The telephone is located adjacent to the display and is operative to provide voice communication to and from the user. The keyboard is located adjacent to and in front of the display and is operative to receive inputs from the user. The first passthrough communication portal includes a first receptacle located adjacent to the display, a second receptacle and a communication link. The first receptacle is operative to receive a communication connector of a computing device. The second receptacle is operative to receive another communication connector for communicating with a communication network such that the communication link propagates information between the computing device and the communication network.

### DESCRIPTION OF THE RELATED ART

People oftentimes have a need to access information when they are away from their homes or offices. This is particularly the case with business people, who sometimes have to travel away from their homes and/or offices for days or even weeks at a time. Typically, such a business person stays at a lodging facility that may provide limited access to the information desired. By way of example, such a facility may provide connectivity to a telephone service so that the business person can make a dial-up connection for checking an e-mail account or downloading information stored at a local area network (LAN) associated with his/her office.

As is known, there is a vast range of services provided by facilities for someone who desires to access information. Thus, a traveler that desires to access information oftentimes is required to travel with a computing device, such as a laptop computer, and the accompanying cords and/or cables that are required to connect the computing device to a communication network. Therefore, when the traveler is faced with a worst-case scenario, i.e., the lodging facility only provides an in-room telephone, the traveler can access information by establishing a dial-up connection with the computing device using the in-room connectivity associated with the telephone. Clearly, such a scenario can be inconvenient for the traveler, can result in the traveler not desiring to stay at a similar lodging facility at a later date, and forces the traveler to be encumbered with an oftentimes expensive and heavy computing device.

### SUMMARY

As should be understood upon reading the accompanying disclosure, various embodiments of systems for providing information to users via communication networks are provided. Such a system involves the use of an integrated appliance that can potentially provide a traveler with the functionality typically provided by a personal computer. Thus, a traveler can use an integrated appliance to access information when away from the home or office. By way of example, the traveler can use such an integrated appliance to type a letter, modify documents, update files, check e-mail and/or access the Internet. Additionally, such an integrated appliance can provide the user with information in the form of dynamic screen content, games, movies, and/or other information, at least some of which may be driven by geographic and/or demographic information associated with the user.

In this regard, an embodiment of such a system comprises an integrated appliance that includes a housing. The housing mounts a display, a telephone, a keyboard and a first passthrough communication portal. The display is operative to display information to the user. The telephone is located adjacent to the display and is operative to provide voice communication to and from the user. The keyboard is located adjacent to and in front of the display and is operative to receive inputs from the user. The first passthrough communication portal includes a first receptacle located adjacent to the display, a second receptacle and a communication link. The first receptacle is operative to receive a communication connector of a computing device. The second receptacle is operative to receive another communication connector for communicating with a communication network such that the communication link propagates information between the computing device and the communication network.

Another embodiment, which is adapted to provide information to a user of a facility via a communication network, comprises an integrated appliance located at the facility. The integrated appliance includes a display, a telephone, a keyboard and a first passthrough communication portal. The display is operative to display. information to the user. The telephone is located adjacent to the display and is operative to provide voice communication to and from the user. The keyboard is located adjacent to the display and is operative to receive inputs from the user. The first passthrough communication portal is operative to receive information from a user-operated computing device and to communicate the information to a communication network such that the integrated appliance facilitates a communication connection between the user-operated computing device and the communication network. The integrated appliance also is operative to provide the user with Internet access and information corresponding to the facility.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a front perspective view of an embodiment of an integrated appliance.

FIG. 2 is a rear perspective view of the embodiment of the integrated appliance of FIG. 1.

FIG. 3 is a partially exploded, perspective view of the embodiment of the integrated appliance of FIGS. 1 and 2.

FIG. 4 is a schematic diagram of another embodiment of an integrated appliance.

FIG. 5A is a schematic diagram of various components of an embodiment of an integrated appliance.

FIG. 5B is a schematic diagram of various components of another embodiment of an integrated appliance.

FIG. 6 is a schematic diagram of an embodiment of a system that can be used to provide information to users via integrated appliances.

FIG. 7 is a schematic diagram of an embodiment of a facility incorporating multiple integrated appliances.

FIG. 8 is a schematic diagram depicting exemplary connectivity between a representative computing device, a representative television and a representative security device interfacing with an embodiment of an integrated appliance.

FIGS. 9-13 are representative screen shots provided by an embodiment of an information system and displayed to a user with an embodiment of an integrated appliance.

### DETAILED DESCRIPTION

As will be describe in detail here, systems for providing information to users are provided that involve the use of integrated appliances. Several embodiments of integrated appliances will be now described.

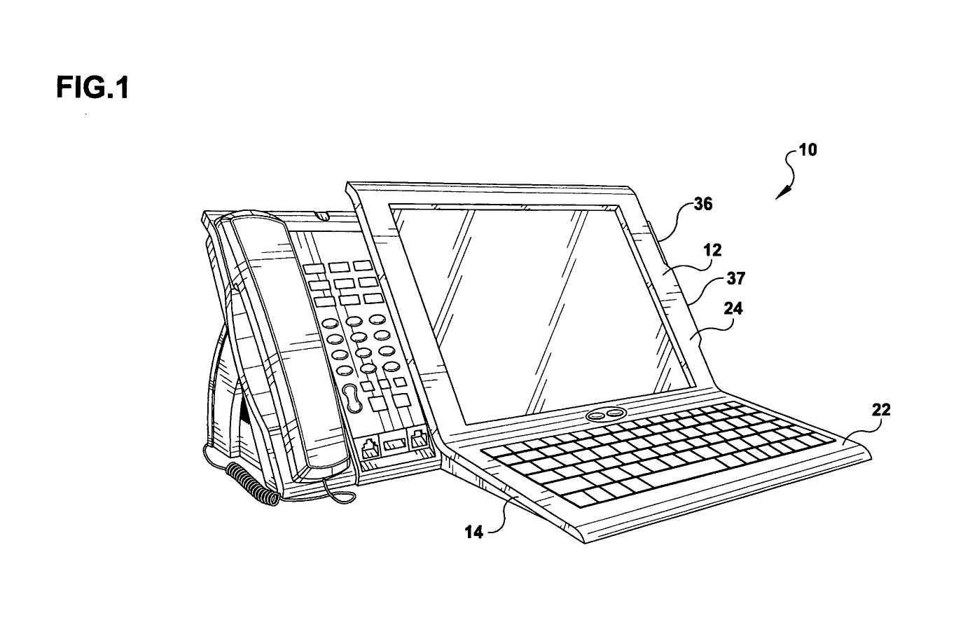

Turning to the drawings, FIGS. 1-3 depict an embodiment of an integrated appliance 10. Integrated appliance 10 includes a housing 12 that is formed of various bezel and covers. Specifically, housing 12 includes a base cover 14, a rear screen cover 16, a rear buttress cover 18, a telephone bezel 20, a keyboard bezel 22 and a screen bezel 24.

Various components are mounted within the housing 12. In particular, keyboard module 30 is seated upon base cover 14, with keyboard bezel 22 securing the keyboard module 30 in position on base cover 14. Keyboard module 30 is located adjacent to and in front of a display assembly that includes an LCD panel 32, a touchscreen plate 34 and a touchscreen 35. By way of example, the display assembly can include a 12.1 touchscreen color LCD with 1024×768 pixel resolution.

The display assembly is supported by the rear screen cover 18, which orients the display assembly in an inclined relationship with respect to the keyboard module 30. Screen bezel 24 surrounds a perimeter of the display assembly.

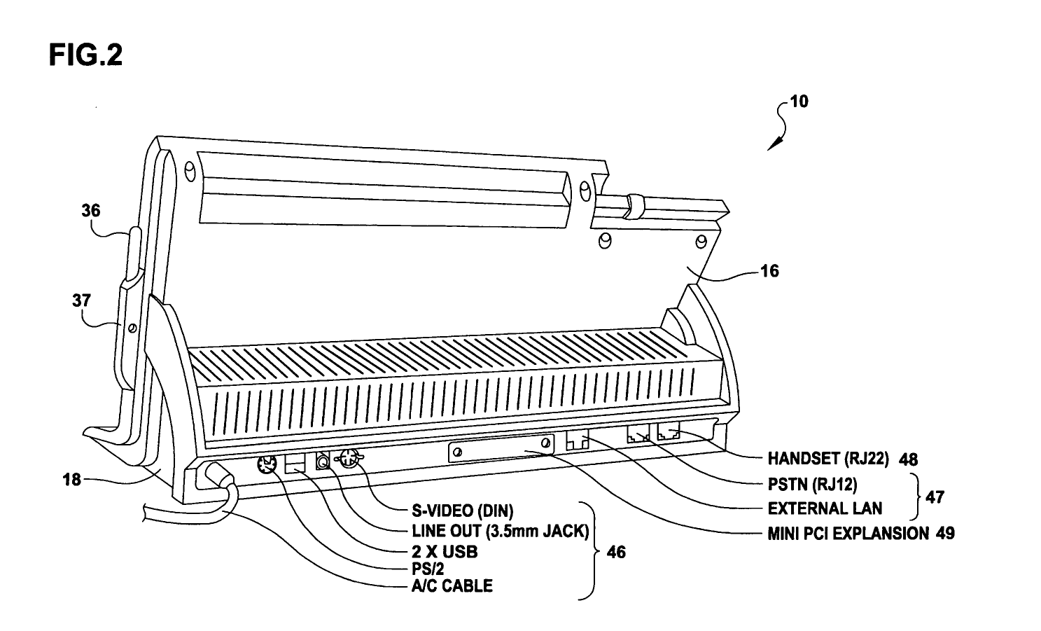

Although preferably operable by a user with the touch of a finger, the embodiment depicted in FIGS. 1-3 includes a stylus 36. As shown best in FIG. 2, stylus 36 can be mounted within a stylus sleeve 37 that is attached to the telephone bezel 24. Thus, when a user desires to use the stylus, stylus 36 can be removed from stylus sleeve 37.

The telephone assembly of the integrated appliance 10 includes a handset 38 that is received by a cradle of telephone bezel 20. The handset 38 includes a microphone and speaker. Telephone bezel 20 also mounts a message-waiting light 39 and a telephone subassembly 40. The message-waiting light 39 illuminates, either intermittently or constantly, when an incoming telephone call is received and/or a telephone message has been saved.

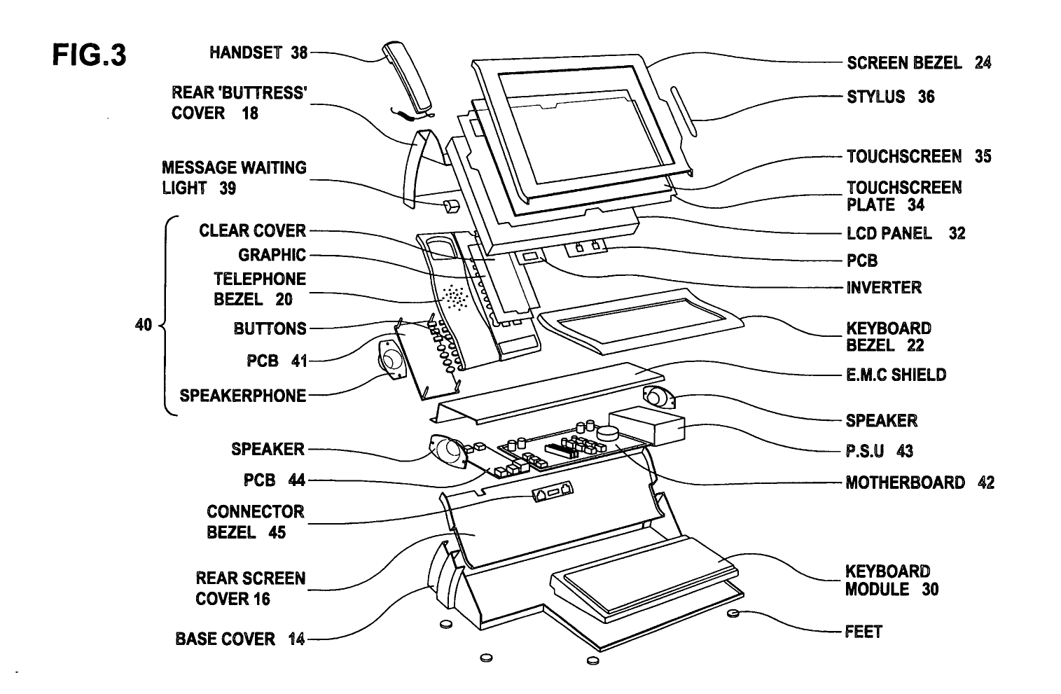

As shown in FIG. 3, telephone subassembly 40 includes a microphone and speaker for hands-free operation, graphics, buttons and a cover. Telephone subassembly 40 also can include actuators for preset one-touch dialing, actuation of one of multiple telephone lines and volume controls, for example.

The telephone assembly also includes a telephone printed circuit board (PCB) 41 for providing various telephony functionality. Telephone PCB 41 is mounted, along with motherboard 42, within the housing 12. A power supply (PSU) 43 also is mounted within the housing and supplies power to the motherboard and various other components after regulating and/or converting power from an external AC power source (not depicted). The PSU preferable is a fanless, open frame, low heat, low wattage PSU.

Motherboard 42 and PCB 44 provide various connectivity associated with the multiple inputs and outputs of the integrated appliance 10. By way of example, the embodiment depicted in FIGS. 1-3 includes a connector bezel 45 that mounts a telephone connector, e.g., an RJ 11 jack, a universal serial bus (USB) connector, and an Ethernet connector, e.g., an RJ 45 jack. As will be described in greater detail later, some embodiments of an integrated appliance can provide communication passthrough functionality.

As used herein, the term “passthrough” refers to communication functionality that is independent of operating system and or software interaction of an integrated appliance. Thus, by providing telephone and Ethernet passthrough, a user can connect a computing device, e.g., a laptop, to a passthrough connector and enable the computing device to communicate with a communication network. Therefore, if the user does not desire to obtain information directly from an integrated appliance, the integrated appliance can accommodate use of the user's computing device.

Various communication connectors are depicted in FIG. 2. In this embodiment, connectors 46 include an S-Video (DIN), line out (3.5 mm jack), two USB connectors, a PS/2 port and an A/C cable. Connectors 47 include a PSTN (RJ12) jack and an external LAN port. A telephone handset jack 48 (RJ22) and a mini PCl expansion slot 49 also are depicted. Clearly, various combinations and arrangements of connectors other than shown in FIG. 2 can be used in other embodiments.

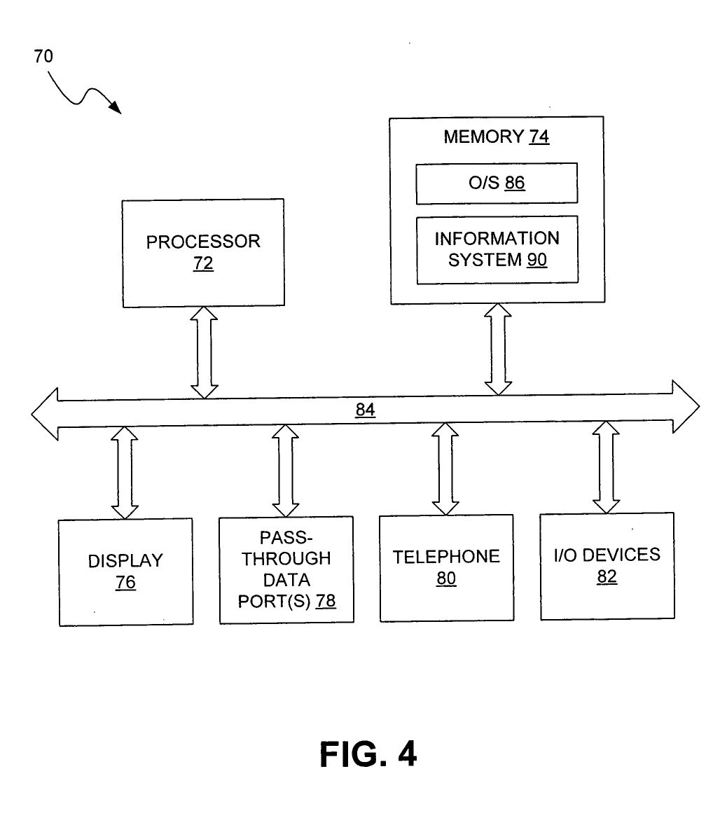

Functionality associated with an integrated appliance, such as described above, can be implemented in software, firmware, hardware, or a combination thereof. When implemented in software, the functionality is implemented as executable programs that can be executed by a special or general-purpose digital processor(s). An example of an integrated appliance that can implement such functionality is shown schematically in FIG. 4.

Generally, in terms of hardware architecture, integrated appliance 70 includes a processor 72, memory 74, and one or more input and/or output (I/O) devices, such as display 76, passthrough data port(s) 78, telephone 80 and various other I/O devices 82, e.g., network connectors, that are communicatively coupled via a local interface(s) 84. The software in memory 74 can include one or more separate programs, each of which comprises an ordered listing of executable instructions for implementing logical functions. In the example of FIG. 4, the software in the memory 404 includes an operating system (O/S) 86 and an embodiment of an information system 90.

When information system 90 is implemented in software, it should be noted that the system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Information system 90 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

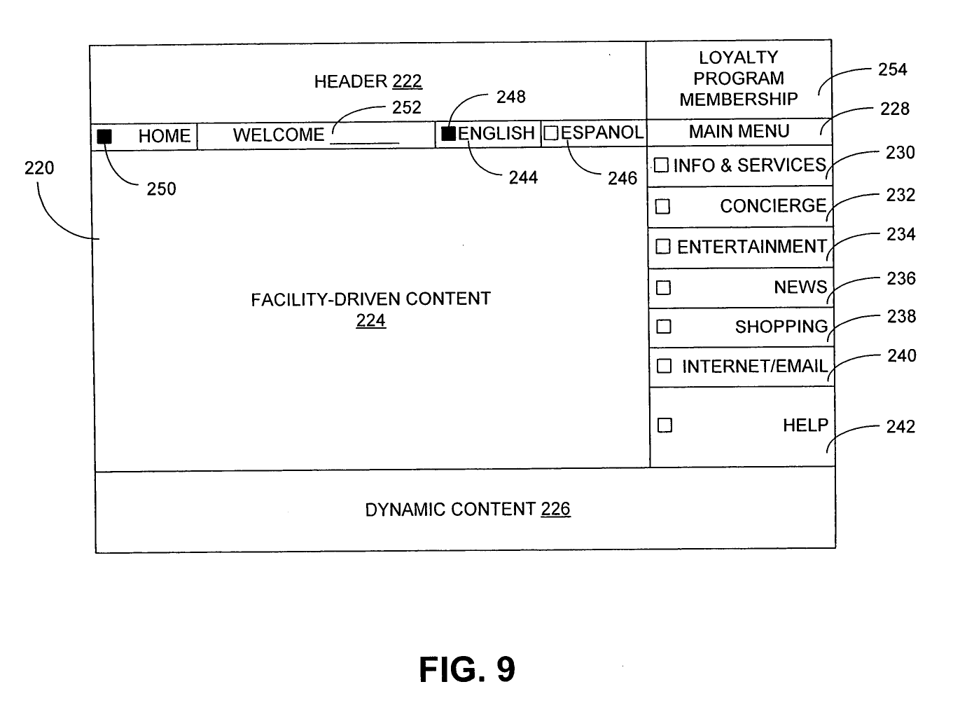

The information system of an integrated appliance can be used to provide various functionality. By way of example, such an information system can be used to provide a user with a graphical user interface (GUI) that includes multiple screens of information. Although multiple representative screen shots will be described in detail later with respect to FIGS. 9-13, general functionality associated with a representative embodiment of an information system will be described here.

By way of example, the embodiment of the information system of FIG. 4 can provide a facility with a display that can be varied based upon the desired look, colors and graphics that the facility desires. Preferably, facility-specific information can be updated locally, e.g., by facility staff. Other content provided by the integrated appliance can be dynamic in nature, in that at least a portion of the content can be provided based upon information corresponding to the particular user or guest. For instance, when the facility is a lodging facility, information corresponding to the name and/or address of the guest can be used to provide personally customized greetings to the guest via the display of the integrated appliance. Further, news associated with the guest's address, e.g., the guest's hometown, also can be provided via the integrated appliance.

Some embodiments of an integrated appliance may not include a local hard drive. Additionally or alternatively, the processor or processors used in an integrated appliance can be fanless, thereby significantly reducing the amount of noise generated by the integrated appliance. In some embodiments, no fans or other internal moving parts are used, thereby rendering these embodiments virtually silent when in operation. This may be particularly desirable when the integrated appliance is used in a hotel room, or the like, where a guest can consider any noise unwelcome.

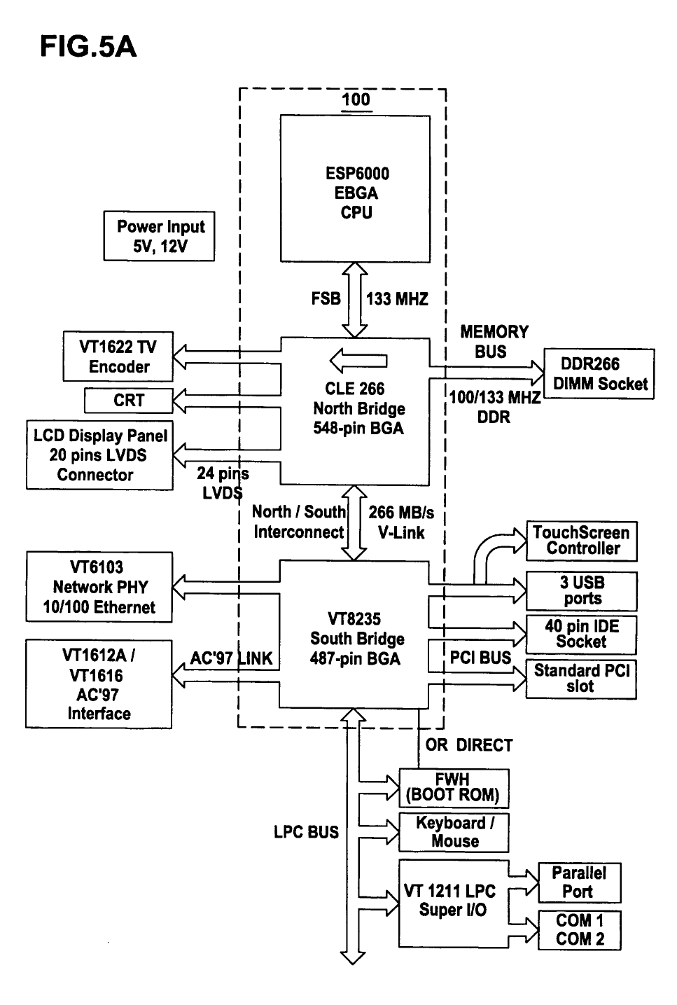

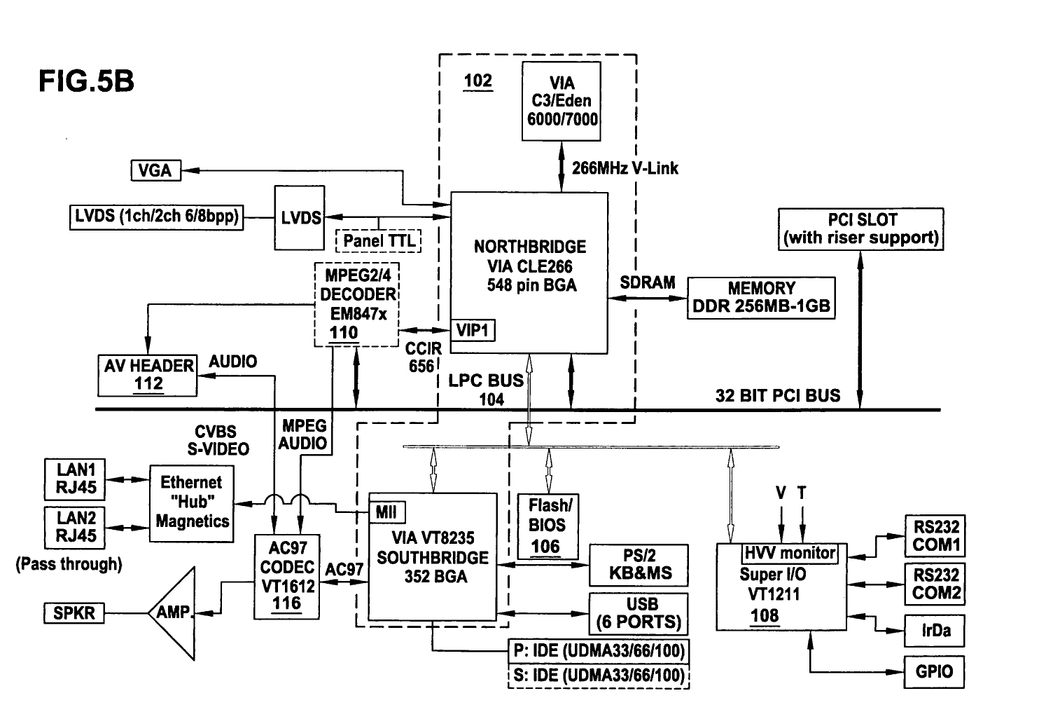

FIGS. 5A and 5B are schematic diagrams of exemplary embodiments of various components and interfaces that can be mounted to and/or within a housing of an integrated appliance. Although readily understood by one of ordinary skill in the art, several of the components/interfaces depicted in FIGS. 5A and 5B will be described in greater detail below.

As shown in FIG. 5A, a fanless processing chipset 100 is included. In this embodiment, chipset 100 can be mounted to a motherboard and incorporates a CPU, such as a C3 or Eden processor, a North Bridge and a South Bridge, each of which is manufactured by Via Technologies, Inc. of Taiwan. Such a CPU provides enhanced digital media performance and a data encryption engine. Low power consumption, low heat and low noise also are potentially advantageous features of using a CPU such as a C3 or Eden processor.

The North Bridge, such as a CLE266, incorporates a video-processing feature set, a 2D/3D graphics engine and a memory controller. Such an embodiment provides a wide range of digital video functions, including MPEG-2 decoding and video scaling for DVD acceleration. The graphics engine is a 128 bit 2D and 64 bit 3D graphics engine with an internal AGP 8X and alpha blending for multi-media and gaming applications. The North Bridge also includes support for a TV encoder, CRT LCD display panel and DIMM socket.

The North Bridge communicates with the South Bridge, such as a VT 8235. Such a South Bridge incorporates support for a touchscreen controller, USB ports, an IDE socket, PCl slot, an Ethernet interface and an MPEG decoder interface. Flash memory/bios (ROM), keyboard/mouse, and an input/output (I/O) controller also communicate with the South Bridge.

In the embodiment of FIG. 5A, the I/O controller is a VT 1211, manufactured by Via Technologies, Inc. of Taiwan. Such a controller includes support for a parallel port interface and 2 serial port interfaces.

The embodiment of FIG. 5B incorporates a fanless processing chip set 102 that includes a CPU, a North Bridge and a South Bridge. The North Bridge communicates with the South Bridge via a low pin count (LPC) bus 104.

In the embodiment of FIG. 5B, the South Bridge incorporates support for USB ports, an Ethernet MAC, PCI support, surround sound audio, and modem support. Flash memory/bios 106 and an input/output (I/O) controller 108 also communicate with the LPC bus 104. The I/O controller 108 includes an IEEE-1284 parallel port interface, 2 serial port interfaces, a very fast IR (VFIR) controller, a game port for supporting two joy sticks, a MIDI interface, and a 4M flash ROM interface.

Also communicating with the North Bridge is an MPEG decoder 110, such as an EM8470 series decoder by Sigma Designs. Such a decoder can support decoding of MPEG data, such as MPEG-2 and MPEG-4, and enables an integrated appliance to provide streaming video, DVD playback, video-on-demand and video-over-IP functionality, as desired. The decoder 110 also communicates with audiovisual headers that can be used for providing audio and video (A/V) to a television, for example.

MPEG decoder 110 communicates with an audio codec 116. By way of example, a VT 1612, manufactured by Via Technologies, Inc. of Taiwan, can be used. Such an audio codec provides two channel outputs for providing stereo quality sound to headphones and/or speaker connections. Four stereo and two mono-audio inputs also are provided that enable connections to a wide range of audio input, such as microphones, line inputs and telephone connections.

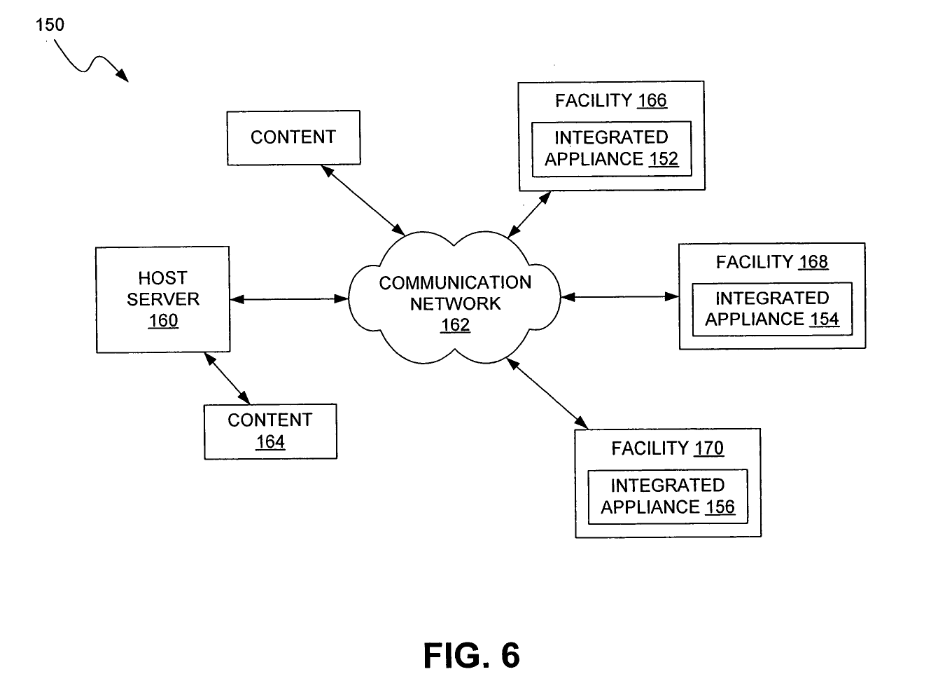

Having thus described several embodiments of an integrated appliance, reference now will be made to FIGS. 6-8, which schematically depict an embodiment of a system that involves the use of integrated appliances for providing information to users. U.S. patent application Ser. No. ______, entitled “Systems and Methods for Generating Multiple Revenue Streams Involving the Use of an Integrated Appliance,” which was filed concurrently herewith, also discloses systems that involve the use of integrated appliances. That application is incorporated by reference herein, except for the definition of “integrated appliance” provided in that disclosure, since multiple embodiments of an integrated appliance are defined herein, such as set forth in the accompanying claims.

As shown in FIG. 6, an embodiment of a system 150 incorporates multiple integrated appliances, e.g., appliances 152, 154 and 156, that communicate with a host server 160. Communication between the host server 160 and the various integrated appliances is facilitated by communication network 162. Note, communication network 162 may be any type of communication network employing any network topology, transmission medium, or network protocol. For example, such a network may be any public or private packet-switched or other data network, including the Internet, circuit-switched networks, such as the public switched telephone network (PSTN), wireless network, or any other desired communications infrastructure and/or combination of infrastructures.

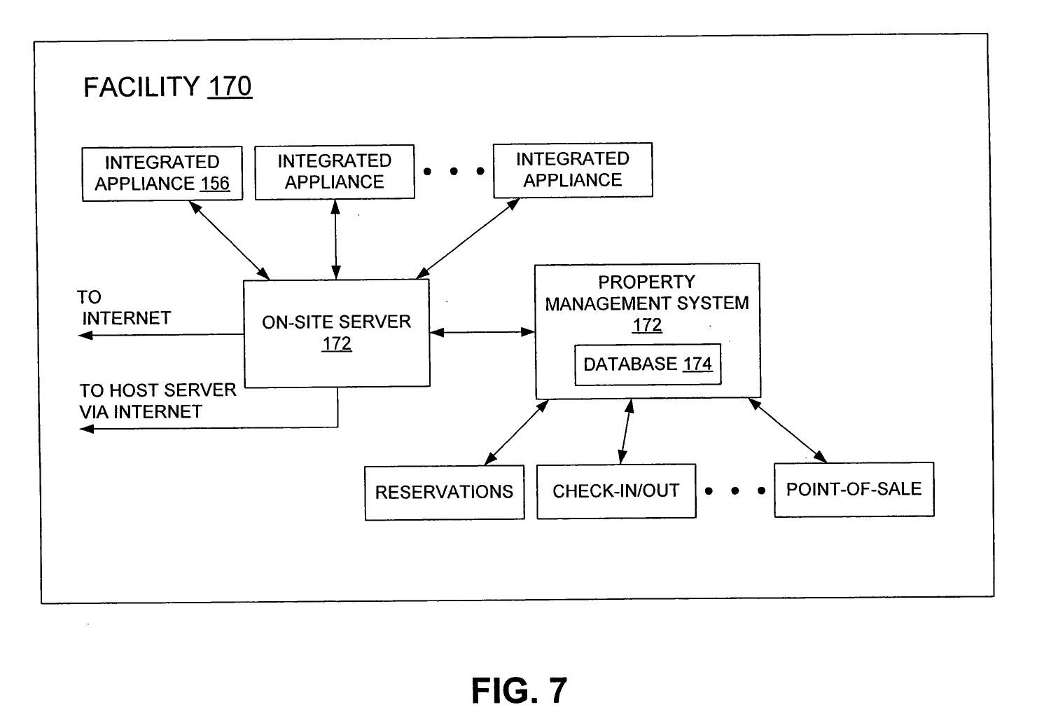

Host server 160, which can comprise one or more server devices, typically is responsible for controlling content distribution, data security, maintenance, and monitoring and reporting of the various integrated appliances that communicate with the host server. By way of example, the host server 160 can facilitate the transfer of content, such as content 164, to an integrated appliance via communication network 162. By way of further example, host server 160 can monitor physical security of an integrated appliance by notifying a facility when a theft condition of the appliance is identified. For instance, if communication with an integrated appliance is disrupted, a notification in the form of an automated message can be sent from the host server and/or on-site server to inform personnel of the condition, such as via email, pager or phone. Note, although multiple facilities, e.g., facilities 166, 168 and 170, and associated integrated appliances are depicted in FIG. 6, reference will now be made to FIG. 7 and facility 170 for the purpose of describing the use of an integrated appliance in providing information to a user.

As shown in FIG. 7, facility 170, which may be a lodging facility such as a hotel, includes multiple integrated appliances. Typically, each integrated appliance, e.g., appliance 156, is located in a separate room or other location, such as a lobby, so that a user can be provided with convenient access to information. Each integrated appliance communicates with an on-site server 172 that provides various functionality to the integrated appliances.

By way of example, the on-site server 172 functions as a web server and provides content to the integrated appliances, such as local content that may be selected by the facility. The on-site server 172 also provides content provided by the host server 160 and directs that content to the appropriate integrated appliance. In some embodiments, the on-site server and integrated appliance use a protocol/booting technique, such as Preboot Execution Environment (PXE). Use of PXE enables the on-site server to store a memory image associated with each integrated appliance. Thus, if one of the integrated appliances needs to be rebooted, its corresponding image is uploaded from the on-site client. Use of such a protocol enables integrated appliances to receive updates of information and/or programming by modifying the stored image and then uploading the modified image on the next reboot.

The on-site server 172 also integrates with the facility telephone system and the facility Property Management System (PMS) 174. In interacting with the PMS system 174, such a PMS system is used to facilitate reservations, check-in/check-out, and potentially various point-of-sale activities, for example, that are undertaken at a facility. To facilitate this functionality, the PMS system 174 typically uses a database 176 that it manages for storing information associated with a user, in this case, a guest of the facility. The on-site server 172, depending upon a relationship established with the facility, can access at least some of the information of the PMS database 176. By way of example, such information can include user name, address, length of stay, type of room (suite or budget room), and registration for events. The on-site server 172 can parse this information and optionally communicate at least some of the information to the host server 160 so that dynamic content can be provided to an integrated appliance corresponding to that user. Thus, the on-site server 172 can direct content associated with a user's hometown to the user via an integrated appliance located in that user's room.

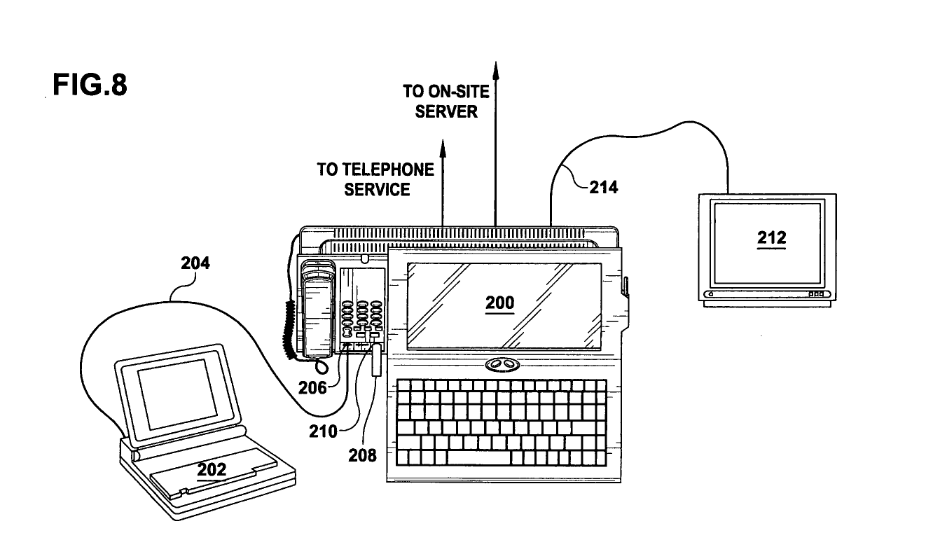

As shown in FIG. 8, an embodiment of an integrated appliance can be used to provide information to a user by interfacing with other devices. For instance, the embodiment of the integrated appliance 200 depicted in FIG. 8 is communicating with a laptop computer 202. Laptop 202 communicates with integrated appliance 200 via cabling 204 that is connected to a passthrough communication port 206 of the integrated appliance. By using the passthrough communication port 206, a user that does not desire to actuate corresponding functionality of the integrated appliance can still send and/or download information using his laptop. However, if the user does not desire to use the laptop, similar functionality can be facilitated by use of the integrated appliance 200, such as by accessing the Internet and/or an e-mail account, as will be described later.

FIG. 8 also depicts use of a security device 208 that is shown inserted in a communication port 210 of the integrated appliance 200. Security device 208 can be a flash memory stick or other device that can contain information for establishing secure communication between the integrated appliance 200 and a network with which the user desires to communicate. Thus, the user could establish a virtual private network (VPN) via use of at least some embodiments of the integrated appliance and an associated security device.

Also shown in FIG. 8 is a television 212. Television 212 receives a television audio/video (AN) signal via cabling 214, such as an svideo and s/pdif (audio). As described before, at least some embodiments of the integrated appliance incorporate the ability to decode MPEG data. Because of this, integrated appliance 200 can receive data in MPEG form, such as via the on-site server, convert the MPEG data into television A/V signals and provide the A/V signals to the television 212. Thus, the user can view television programming on the television and/or the integrated appliance. In some embodiments, the television and integrated appliance can provide the same or different video and audio. Note, embodiments of an integrated appliance can be used to play audio, such as digital audio files from a digital media library.

Various other features also can be implemented in some embodiments. For instance, some integrated appliances can be designed and/or manufactured in a modular format. Specifically, a mini-PCl interface on a SODIMM form factor can be provided, as well as a standard 32 bit PCI socket, 2 two-channel IDE interfaces, and possibly additional sockets for manufacturing-time chipset options. Various modules can include a wireless 802.11g module for mini-PCl expansion, an MPEG decoder/TV encoder card for the PCl socket, an IR receiver, and a separate voice-over-IP module interfacing between the telephone PCB and the telephone jacks.

In those embodiments incorporating an IR receiver, the IR receiver can be used to detect signals provided by a television IR remote control. Such an integrated appliance can attribute the various remote control signals to corresponding functions provided by the integrated appliance so that a user can playback video/audio on the integrated appliance and/or associated television using the remote control. In other embodiments, a separate IR controller can be provided.

With respect to embodiments that incorporate voice-over-IP (VOIP), the telephone handset and telephone electronics can be used to place and receive telephone calls that are intercepted by a VOIP module and transformed into digital VOIP packets sent over the network to an associated on-site server. The on-site server sends the VOIP packets to a VOIP gateway, either on the Internet, or located at the facility.

With respect to casualty modes of operation, some embodiments of an integrated appliance are able to provide limited functionality even when power outages occur. For instance, the ability to dial 911 can be provided during a power outage, i.e., some embodiments function like an analog telephone in that respect. In those embodiments that incorporate VOIP functionality, a power outage can cause the integrated appliance to default to analog telephone service as well. Also, in those embodiments that incorporate power-over-Ethernet service, Ethernet service also can be provided under a power outage condition if the equipment facilitating such service, e.g., the on-site server has a functioning power back-up.

Security implementations also are provided in some embodiments. For instance, some embodiments support the 802.1q protocol providing for a separate VLAN tag for a computing device, such as a laptop. This 802.1q support integrates with upstream network equipment providing seamless security between a 3rd party network or HSIA solution, and the computing device.

Reference will now be made to FIGS. 9-13, which are representative screen shots that can be displayed by an embodiment of an integrated appliance for facilitating at least some of the functionality described above. As shown in FIG. 9, which depicts a screen shot provided by a graphical user interface (GUI) via a display assembly of an integrated appliance, the user is provided with information in various forms. Specifically, screen shot 220 includes a header 222 that can be standardized across the various screen shots provided by the GUI. By way of example, when the screen 220 is associated with a lodging facility, the name of the lodging facility could be displayed in the header 222. Screen 220 also includes fields for facility-driven content and dynamic content, which are depicted as fields 224 and 226, respectively. As mentioned before, the facility-driven content can be provided and/or modified by the facility so that information that may change on a daily basis, for example, can be managed on-site. In contrast, the dynamic content provided in field 226 can be provided by a host server and/or on-site server associated with the integrated appliance, and can be used to provide geographic and/or demographically driven information to a particular user.

Screen 220 also includes a menu 230 which, in this embodiment, includes an actuator or link for accessing information & services 230, concierge 232, games & entertainment 234, news 236, shopping 238, Internet/e-mail 240 and help 242. Note, several of the aforementioned menu items will be described in detail later.

Screen 220 also includes functionality for changing the language of the display. In particular, screen 220 includes an English actuator 244 and a Spanish actuator 246. Note that the English actuator 244 is actuated, with an indicator 248 being illuminated to indicate that the English language has been selected. An indicator 250 also is provided to show that screen 220 is indicative of the home page of the GUI. A “welcome” field 252 also is provided within which the name of a user can be displayed. This enables the screen to be customized based upon the anticipated user.

A loyalty program membership actuator 254 also is provided that can be actuated by a user to enroll and/or utilize aspects of a loyalty program that is facilitated by the integrated appliance. In this regard, depending on various business relationships established with loyalty programs, the integrated appliance can be used to receive user inputs for converting loyalty reward points, and the like, for use in upgrading amenities, for example, that can be provided through the integrated appliance.

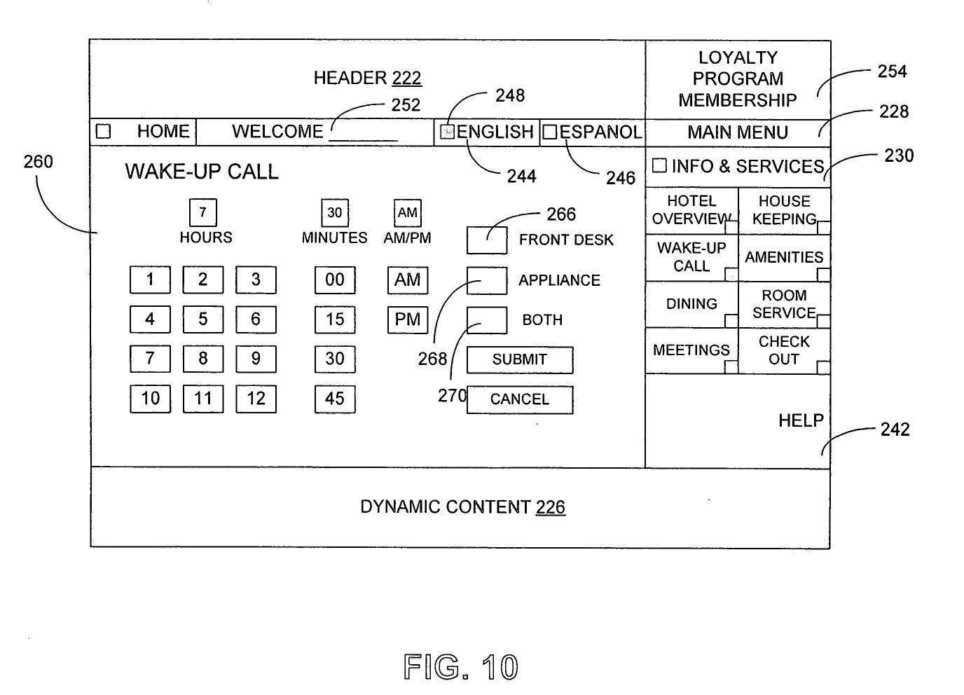

Referring now to FIG. 10, a screen 260 is depicted that can be provided in response to a user actuating the information & services actuator 230 of FIG. 9. As shown in FIG. 10, screen 260 includes various actuators for establishing a wake-up call for the user. In this regard, a virtual keypad is depicted that can be used for entering the time that a wake-up call is desired. Also note that various options are provided in the form of actuators 236, 237 and 238 for enabling the user to select the manner in which the wake-up call is to be accomplished. In this embodiment, actuator 266 corresponds to the user desiring a telephone call for wake-up, actuator 268 corresponds to the integrated appliance waking the user with audio provided by the onboard speaker and/or video on the display, and actuator 270 corresponds to both of the aforementioned forms of wake-up. An actuator 272 then can be used to submit information corresponding to the desired wake-up call to the on-site server so that the aforementioned functionality can be accomplished. Note that, in some embodiments, information is communicated to the Property Management System or facility telephone system (PBX), for example, so that a wake-up call can occur.

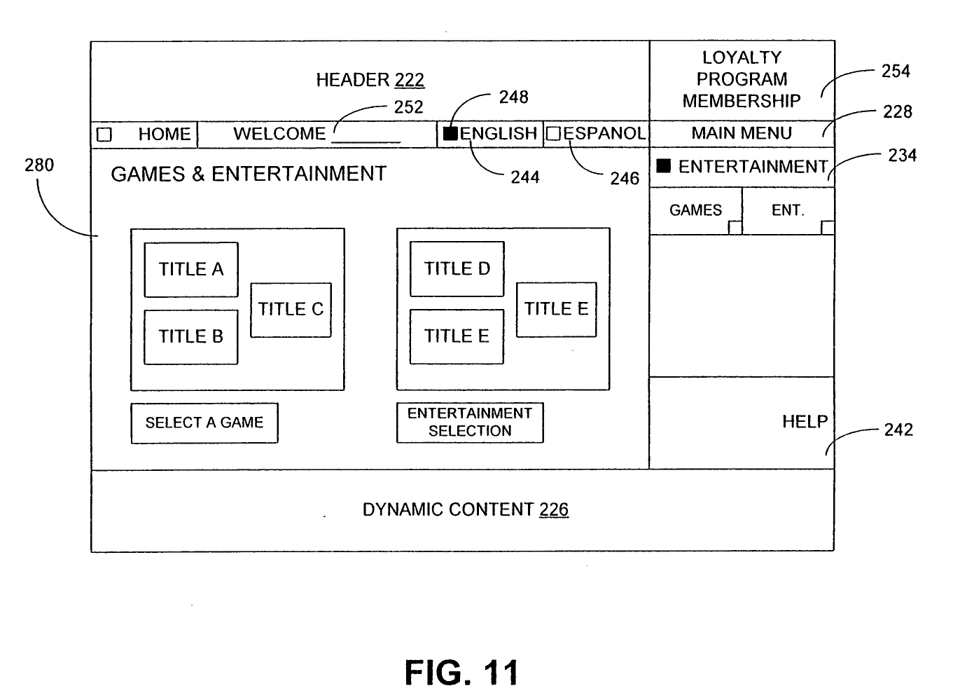

FIG. 11 depicts a screen 280 that can be provided to a user when actuator 234 is actuated. As shown in FIG. 11, the user is provided with a selection of games and/or entertainment, such as movies, that can be provided by an integrated appliance. Note that, in some embodiments, when either a game or movie is selected, a charge can be posted to the user's facility account, thereby generating revenue for the facility. As mentioned before, gaming functionality can involve the use of a game controller, for example, that can be interconnected to an integrated appliance through one or more of the various communication connectors. Similarly, movies can be displayed to the user via a television that receive television signals from the integrated appliance. Note that in addition to, or in lieu of, displaying gaming or movies with the display assembly of an integrated appliance, the games and movies can be displayed with a television that is communicating with the integrated appliance.

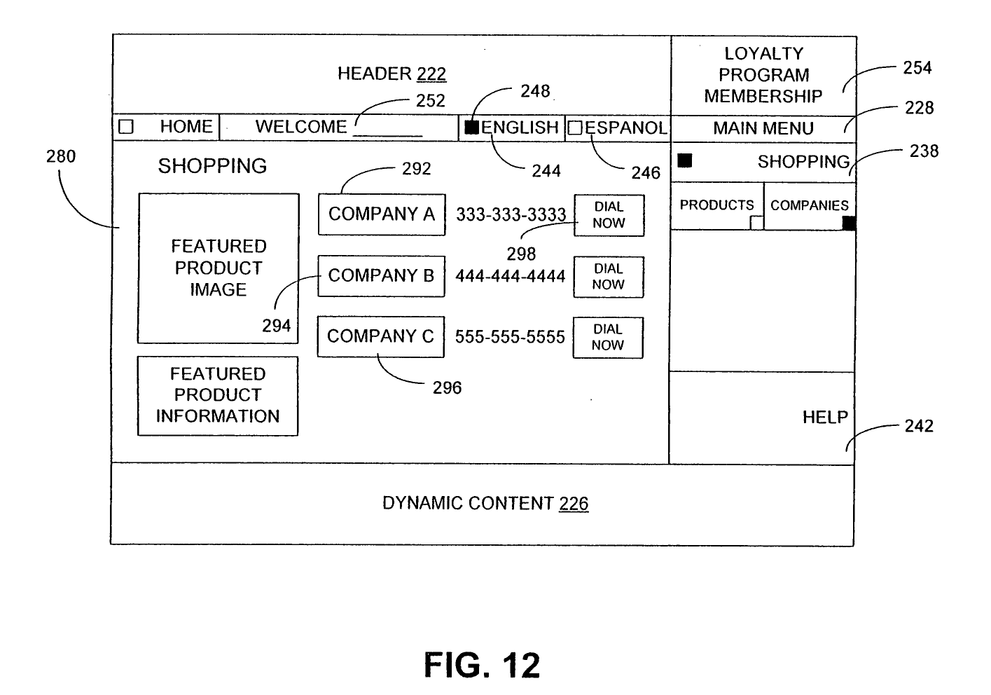

FIG. 12 depicts a screen 290 that can be displayed to a user in response to actuating shopping actuator 238. Screen 290 includes various actuators or links, such as actuators 292, 294, 296, each of which corresponds to a particular product, line of products, or company, for example. Also associated with each of the product actuators is a “dial now” actuator. For instance, dial now actuator 298 corresponds to the company actuator 292. Thus, when the user actuates dial now actuator 298, a telephone connection automatically is established between the telephone of the integrated appliance and the establishment associated with the company actuator. Therefore, the user does not have to dial the telephone number and may be more likely to follow through with an impulse purchase. Information corresponding to such a purchase also could be acquired by the on-site server and potentially communicated to an associate host server so that dynamic content corresponding to such a purchase can be provided to the user.

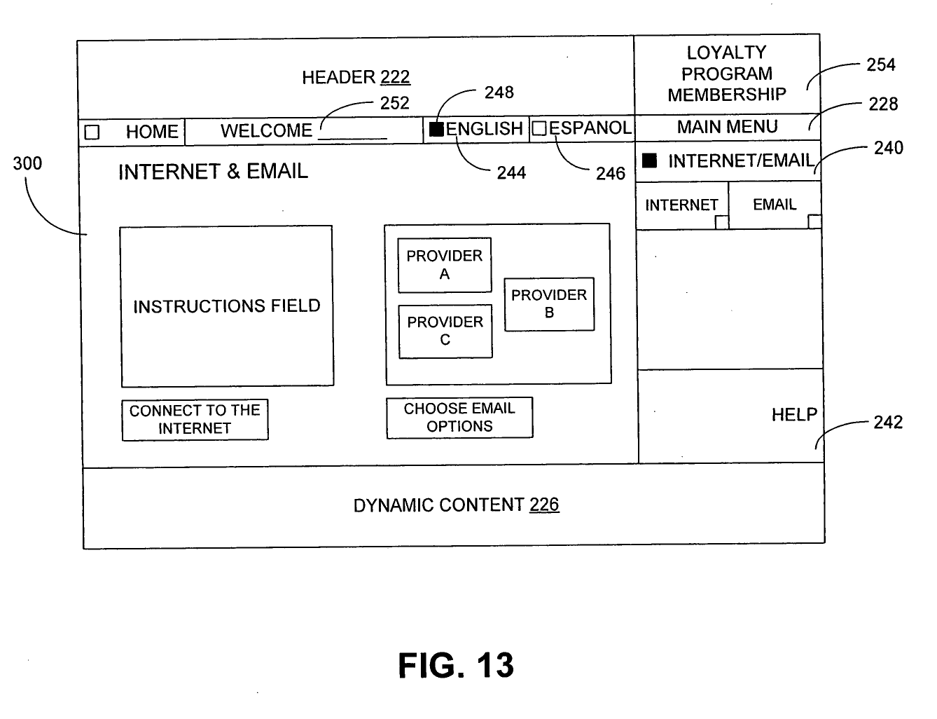

FIG. 13 depicts a screen 300 that can be displayed to a user in response to actuating the Internet/e-mail actuator 240. Screen 300 includes actuators 302 and 304 for enabling a user to connect with the Internet and to check e-mail, respectively. As mentioned before, if a user does not desire to use the Internet and/or e-mail functionality provided by an integrated appliance, the user can use the passthrough data connectivity provided by an integrated appliance.

It should be emphasized that many variations and modifications may be made to the above-described embodiments. All such modifications and variations are intended to be included herein within the scope of this disclosure and protected by the following claims.

1. A system for providing information to a user via a communication network, said system comprising:
an integrated appliance having a housing, the housing mounting a display, a telephone, a keyboard and a first passthrough communication portal;
the display being operative to display information to the user;
the telephone being located adjacent to the display and being operative to provide voice communication to and from the user;
the keyboard being located adjacent to and in front of the display and being operative to receive inputs from the user;
the first passthrough communication portal having a first receptacle located adjacent to the display, a second receptacle and a communication link therebetween, the first receptacle being operative to receive a communication connector of a computing device therein, the second receptacle being operative to receive another communication connector for communicating with a communication network such that the communication link propagates information between the computing device coupled to the first receptacle and the communication network coupled to the second receptacle.

2. The system of claim 1, wherein the integrated appliance further comprises:
a high-speed Internet port mounted to the housing;
a video output port mounted to the housing and operative to communicate signals to a television for display; and
an MPEG converter operative to receive information from the high-speed Internet port, to covert the information and to provide the information converted to the video output port.

3. The system of claim 2, further comprising:
a television communicating with the video output port of the integrated appliance such that an MPEG file received and converted by the integrated appliance is displayed to a user via the television.

4. The system of claim 3, wherein, when the television is displaying images corresponding to the MPEG file, the integrated appliance is operative to display other images.

5. The system of claim 1, wherein the integrated appliance further comprises:
memory mounted within the housing and operative to store processor-executable instructions; and
a fanless processor mounted within the housing and operative to execute the instructions stored in the memory.

6. The system of claim 5, wherein:
the integrated appliance further comprises:
a network communication port mounted to the housing and operative to receive information from a communication network; and
the instructions stored in the memory are dynamically alterable with information received via the network communication port.

7. The system of claim 1, wherein:
the first passthrough communication portal is an analog telephone communication portal; and
the integrated appliance further comprises:
an Ethernet communication port mounted to the housing.

7. The system of claim 1, wherein the integrated appliance further comprises:
a security device having an internal memory, the internal memory comprising information for authenticating a user such that, when the security device is coupled to the integrated appliance and communicates the information from the internal memory, the user is provided secure access to a communication network associated with the user.

8. The system of claim 1, wherein:
the integrated appliance is operative to provide voice-over-IP functionality; and
when operating in a power-outage mode, the voice-over-IP functionality defaults to analog telephone functionality.

9. The system of claim 1, wherein:
the integrated appliance is operative to display indicia corresponding to a telephone number via the display; and
in response to actuating the indicia on the display, the integrated appliance automatically establishes telephone communication using the telephone number.

10. The system of claim 1, further comprising:
an on-site server communicating with the integrated appliance, the on-site server being operative to provide locally-stored information to the user via the integrated appliance.

11. The system of claim 10, further comprising:
a host server communicating with the integrated appliance via the on-site server, the host server being operative to provide content to the user via the integrated appliance.

12. The system of claim 11, wherein:
the host server is operative to monitor the integrated appliance such that, if the host server monitors a theft condition of the integrated appliance, the host server automatically communicates the theft condition.

13. The system of claim 11, wherein:
the integrated appliance is a first integrated appliance, and the on-site server is a first on-site server; and
further comprising:
multiple other integrated appliances and multiple other on-site servers, the other on-site servers communicating with the host server.

14. The system of claim 11, further comprising:
a Property Management System communicating with the on-site server, the Property Management System being operative to maintain a database of information corresponding to a user and to provide at least some of the information from the database to the on-site server.

15. The system of claim 14, wherein:
the on-site server provides the information from the database to the host server; and
the host server uses the information received from the on-site server to select the content for providing to the user via the integrated appliance.

16. The system of claim 14, wherein:
the database comprises demographic information corresponding to the user; and
the content provided to the user via the integrated appliance is based, at least in part, on the demographic information.

17. A system for providing information to a user of a facility via a communication network, said system comprising:
an integrated appliance located at the facility and having a display, a telephone, a keyboard and a first passthrough communication portal;
the display being operative to display information to the user;
the telephone being located adjacent to the display and being operative to provide voice communication to and from the user;
the keyboard being located adjacent to the display and being operative to receive inputs from the user;
the first passthrough communication portal being operative to receive information from a user-operated computing device and to communicate the information to a communication network such that the integrated appliance facilitates a communication connection between the user-operated computing device and the communication network;
the integrated appliance being operative to provide the user with Internet access and information corresponding to the facility.

18. The system of claim 17, wherein:
the first passthrough communication portal comprising an RJ11 jack; and
the integrated appliance further comprises:
a second passthrough communication portal comprising an RJ45 jack.

19. The system of claim 17, wherein the integrated appliance is operative to receive voice from a user via a handset of the telephone and to provide voice-over-Internet for communicating information corresponding to the voice over a communication network.

20. The system of claim 17, further comprising:
an on-site server located at the facility and communicating with the integrated appliance, the on-site server being operative to provide locally-stored information to the user via the integrated appliance.

21. The system of claim 20, further comprising:
a host server located remote from the facility and communicating with the integrated appliance via the on-site server, the host server being operative to provide content to the user via the integrated appliance.

22. The system of claim 20, further comprising:
means for providing content to the user via the integrated appliance.
